(19) United States
(12) Patent Application Publication
(10) Pub. No.: US 2020/0410056 A1
(43) Pub. Date: Dec. 31, 2020

(54) GENERATING MACHINE LEARNING TRAINING DATA FOR NATURAL LANGUAGE PROCESSING TASKS

(71) Applicant: Microsoft Technology Licensing, LLC, Redmond, WA (US)

(72) Inventors: Yang Chen, Sunnyvale, CA (US); Xiaohai Zhang, San Francisco, CA (US); Michael A. Menarguez, Dublin, CA (US); Haifeng Zhao, San Jose, CA (US); Liang Zhang, Fremont, CA (US)

(21) Appl. No.: 16/455,393

(22) Filed: Jun. 27, 2019

(51) Int. Cl. G06F 17/27; G06N 20/00

(52) U.S. Cl. CPC G06F 17/2785; G06N 20/00; G06F 17/278; G06F 17/274

(57) ABSTRACT

A crowdsource pipeline manager that is capable of using a crowdsource platform to automatically generate a large amount of high-quality training examples in a timely manner for training a machine learning model for a natural language processing task. Instead of merely creating a collection job with the crowdsource platform, the crowdsource pipeline manager creates a peer-reviewed collection job. The peer-reviewed collection job is created with the crowdsource platform such that execution of a corresponding judging job by the crowdsource platform is automatically triggered after the crowdsource platform executes the peer-reviewed collection job.

### TECHNICAL FIELD

The present invention relates generally to data processing environments. In particular, the present invention relates to computer-implemented techniques for generating machine learning training data for natural language processing tasks.

### BACKGROUND

Computers are very powerful tools for performing a wide variety of information processing tasks. One task computers are improving at seemingly every day now is natural language processing. Natural language processing typically involves a computer applying a trained machine learning model to unstructured unannotated text in order to predict things about the text. The form of the overall prediction can be the input text annotated with the predictions.

One type of thing that a trained machine learning model can predict about text can include what are the parts of speech in the text. The parts of speech in text that a trained machine learning model can predict can include what are the nouns, verbs, adjectives, etc. in the text. A trained machine learning model that can predict parts-of-speech in unstructured text is sometimes referred to as a parts-of-speech (POS) tagger, or just “POS tagger,” because it is capable of “tagging” portions of text with parts-of-speech tags. As a simple example, the unannotated text “The quick brown fox.” could be tagged by a POS tagger as the annotated text “[The]_{determiner} [quick]_{adjective} [brown]_{adjective} [fox]ₙₒᵤₙ”

Another type of thing that a trained machine learning model can predict about text can include what are the named entity mentions in the text and to which pre-defined categories do the named entity mentions belong. The pre-defined categories can include, as just some examples, first names, last names, organizations, geographic locations, dates, times, monetary values, percentages, etc. A trained machine learning model that can predict named entity mentions in unstructured text is sometimes referred to as named entity recognition (NER) system, or just “NER system,” because it is capable of “recognizing” or “tagging” keywords or keyphrases in text that belong to one of the pre-defined categories. As a simple example, the unannotated text “The quick brown fox” might be tagged by a NER system as the annotated text “The quick [brown]_{color} [fox]ₐₙᵢₘₐₗ” where colors and animals are two pre-defined categories of entities that the NER system is trained to recognize.

Whether a POS tagger, a NER system, or other type of trained machine learning model for natural language processing, the model is typically trained in a supervised learning manner with labeled text before the trained model is used to make predictions for unlabeled text. The labeled text is sometimes referred to as training examples and the unlabeled text is sometimes referred to as test examples. The test examples are usually not included in the training examples. In general, a goal of the training process is to learn a function that is capable of predicting, as accurately as possible, the correct label for each input test example based on the set of labeled training examples. Example types of machine learning models that can be trained in a supervised learning manner for natural language processing tasks include support vector machines (SMVs), Bayesian network models, maximum entropy models, conditional random field (CRF) models, and deep neural network models.

Although not strictly true in every case, it is generally true that when training a machine learning model for a natural language processing task, the more representative training examples used for training, the better. Amassing enough training examples for natural language query processing tasks is challenging. For example, consider a large-scale social network service that serves tens or hundreds of millions of users daily. The service may provide a search feature to users that allows them to enter natural language queries. In order for the service to identify and return the most relevant search results to users in response to the queries, the service may employ trained machine learning models for performing various natural language processing tasks such as POS tagging and NER. In order for these trained models to be effective at supporting the service in identifying and returning the most relevant search results available, the models may need to be trained with large sets of training examples.

The present invention addresses these and other issues.

The approaches described in this section are approaches that could be pursued, but not necessarily approaches that have been previously conceived or pursued. Therefore, unless otherwise indicated, it should not be assumed that any of the approaches described in this section qualify as prior art, or are well understood, routine, or conventional, merely by virtue of their inclusion in this section.

### BRIEF DESCRIPTION OF THE DRAWINGS

In the drawings:

FIG. 1 schematically depicts an example system for generating machine learning training data for a natural language processing task.

FIG. 2 is a wire-frame depiction of an example collection prompt.

FIG. 3 is a wire-frame depiction of an example judging prompt.

FIG. 4 is a wire-frame depiction of an example tagging prompt.

FIG. 5 is a flowchart of an example process for generating machine learning training data for a natural language processing task.

FIG. 6 is a block diagram of an example computer system that can be used in a computing system implementation of the example system of FIG. 1 and the example process of FIG. 5.

### DETAILED DESCRIPTION

In the following description, for the purposes of explanation, numerous specific details are set forth in order to provide a thorough understanding of the present invention. It will be apparent, however, that the present invention can be practiced without these specific details. In other instances, well-known structures and devices are shown in block diagram form in order to avoid unnecessarily obscuring the present invention.

### General Overview

Crowdsource platforms exist for acquiring machine learning training data from a “crowd” of users. However, current techniques for obtaining training data using crowdsource platforms suffer from lack of quality in the obtained training examples and long-time delays between (a) submitting a collection job to the crowdsource platform and (b) receiving a sufficient number of quality training examples to begin the machine learning training task.

The lack of quality can be caused by a variety of reasons including a misunderstanding by crowd users of what the collection job is asking them to provide, or simply apathy or disinterest on the part of the crowd users due to the tedious and repetitive nature of the crowdsourcing task. With some crowdsource platforms, crowd users may receive a payment or reward (monetary or otherwise) for submitting training examples. Some crowd users may rapidly compose and submit gibberish or other malformed text in an attempt to “cheat the system” and receive the payment or reward without having to take the time to compose a thoughtful and responsive training example. The long-time delays can result from a lack of urgency of crowd users responding to collection prompts. The result is that an online service that uses a crowdsource platform to obtain machine learning training data from crowd users may have to: (a) wait more than a desired amount of time (e.g. weeks) before it receives a sufficient number of useable training examples from the crowdsource platform and/or (b) filter out many low quality (e.g., useless) training examples.

The present invention addresses these and other issues.

The present invention encompasses a crowdsource pipeline manager that is capable of using a crowdsource platform to automatically generate a large amount of high-quality training examples in a timely manner for training a machine learning model for a natural language processing task. Instead of merely creating a collection job with the crowdsource platform, the crowdsource pipeline manager creates a “peer-reviewed” collection job. The peer-reviewed collection job is created with the crowdsource platform such that execution of a corresponding “judging” job by the crowdsource platform is automatically triggered after the crowdsource platform executes the peer-reviewed collection job.

A purpose of the peer-reviewed collection job is to collect a candidate training example from a crowd user. A purpose of the judging job is to have another crowd user judge the quality of the candidate training example collected. Only candidate training examples judged to be well-formed are generated as training examples. In this way, high-quality, peer reviewed training examples can be automatically generated.

In addition, once a first crowd user submits the candidate training example, the corresponding judging job can then automatically be executed by the crowdsource platform. As a result, a training example can be generated while other peer-reviewed collection jobs are still pending receipt of a candidate training example. In this way, training examples can be generated in a pipeline fashion as opposed having to wait until candidate training examples are collected by crowd users for all peer-reviewed collection jobs before generating the first training example. Because of the streaming pipeline nature of training example generation, once a sufficient number of training examples are generated for the machine learning training task at hand, the training can begin even if there are peer-reviewed collection jobs still pending with the crowdsource platform. There is no need to wait until all peer-reviewed collection jobs are no longer pending before beginning training.

Thus, the present invention improves the operation of online services that use training data for training machine learning models for natural language processing tasks. It does this by: (1) automatically generating high-quality training examples that have been peer reviewed using a crowdsource platform, and (2) automatically generating the high-quality training examples more quickly using a pipeline approach.

These and other advantages of the present invention will now be described in greater detail below with respect to the figures.

### Example System for Generating Machine Learning Training Data for a Natural Language Processing Task

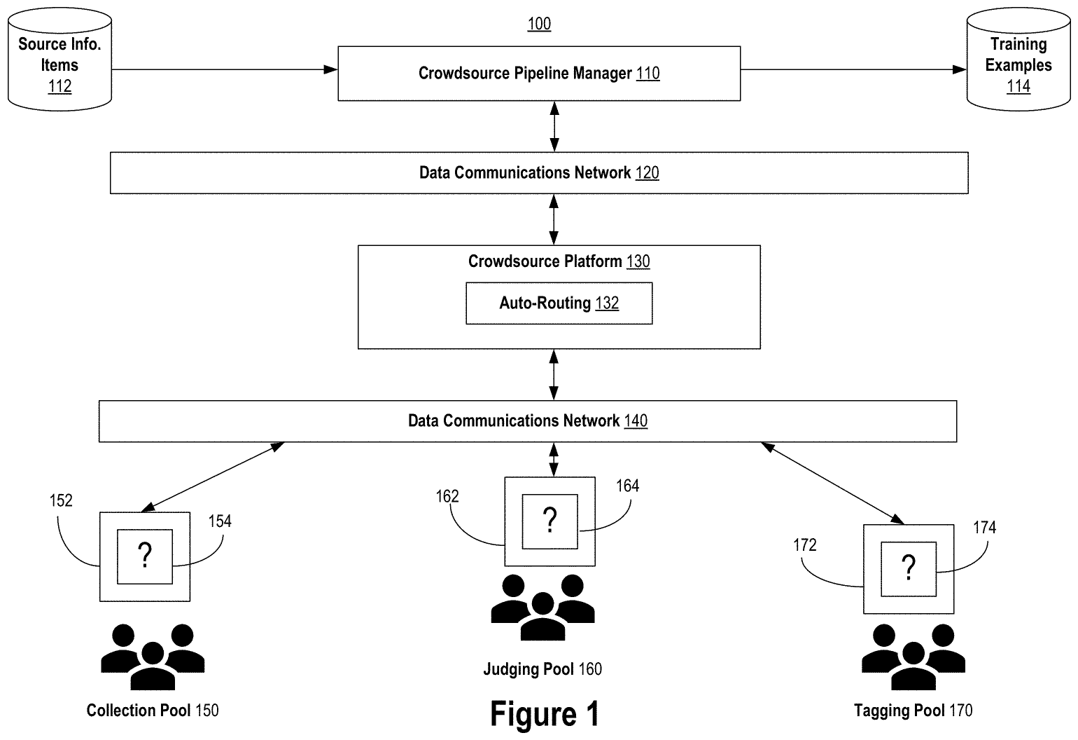

FIG. 1 schematically depicts example system 100 for generating machine learning training data for a natural language processing task. In this example, the natural language processing task is named entity recognition. In particular, system 100 can be used by an online service to generate a sufficient number of useful, high-quality training examples for training a NER system. The NER system can be for tagging entities in natural language search queries, for example. However, one skilled in the art will recognize from this description that example system 100, with the appropriate modifications, can be used for generating machine learning training data for other natural language processing tasks such as, for example, POS tagging tasks, natural language translation tasks, and image captioning tasks.

System 100 includes crowdsource pipeline manager 110 (“manager 110”) and crowdsourcing platform 130 (“platform 130”). Each of manager 110 and platform 130 can execute using one or more computer systems. Manager 110 is connected to platform 130 by data communications network 120. Crowd user personal computing devices 152, 162, and 172 are connected to platform 130 by data communications network 140. Network 120 may be the same or a different network than network 140. No particular type or types of data communications networks are required of network 120 and network 140. For example, network 120 and network 140 can each include one or more Internet Protocol (IP)-based networks, or other type or types of data communications networks. Crowd user devices 152, 162, and 172 can each be any type of portable or stationary personal computing device such as, for example, a desktop computer, a laptop computer, a smartphone, a tablet computer, etc. Crowd user devices 152, 162, and 172 can be, but do not all need to be, the same type of personal computing device. A crowd user in collection pool 150, judging pool 160, and tagging pool 170 can also be in one or both of the other pools. Thus, crowd user devices 152, 162, and 172 need not be distinct sets of devices. However, it is also possible for crowd users in pools 150, 160, and 170 to be distinct sets of crowd users and corresponding distinct sets of user devices 152, 162, and 172. Crowd users in collection pool 150 are presented with collection prompts 154 at their user devices 152. Crowd users in judging pool 160 are presented with judging prompts 164 at their user devices 162. Crowd users in tagging pool 160 are presented with tagging prompts 174 at their user devices 172. Non-limiting examples of a collection prompt, a judging prompt, and a tagging prompt are provided herein.

Manager 110 can be operated by the online service which can be, for example, a large-scale social network. Herein, the term “social network” will be used broadly to refer to any type of network representing connections or relationships between users of the online service that facilitates online user interaction or online user collaboration via the online service. For example, the social network can encompass any of a friends and family social network (e.g., Facebook™, Twitter™, Google+™, MySpace™, or the like), a multimedia sharing social network (e.g., YouTube™, Flickr™, Instagram™, or the like), a professional social network (e.g., Linkedln™, Classroom 2.0™, or the like), or an informational social network (e.g., Quora™, Nextdoor™, or the like).

While examples are provided herein in the context of a large-scale professional social network, the techniques disclosed herein are not limited to any particular type of social network or any particular type of online service, or even a large-scale online service, and one skilled in the art will recognize from this disclosure that the techniques can be applied in the context of a variety of different types of social networks and online services, including smaller-scale online services such as those that serve mostly only users in a particular company, organization, school, hospital, governmental agency, etc.

Crowdsource platform 130 can be operated by the online service. Alternatively, crowdsource platform 130 can be operated by a third-party service provider. For example, crowdsource platform 130 can be the Figure Eight™ platform operated by Figure Eight Inc. of San Francisco, Calif. Whomever operates crowdsource platform 130, platform 130 can generally be any online computer platform that uses humans to do simple tasks such as transcribing text or annotating images for training machine learning algorithms. The FIG. Eight™ platform is just one example of such a platform and other like crowdsource platforms can be used instead.

The high-level operation of manager 110 can include obtaining set of source information items 112 from one or more files and/or one or more databases or other computer data containers. Manager 110 can then submit each source information item to platform 130 over network 120 to create a peer-reviewed collection job for the source information item. For creating a peer-reviewed collection job with platform 130, platform 130 may offer an application programming interface (API) invokable over network 120 by which peer-reviewed collection jobs can be created by manager 110 with platform 130. The API may be invokable over data communications network 120 using a suitable application-layer networking protocol such as the Hyper-Text Transfer Protocol (HTTP) or the Secure Hyper-Text Transfer Protocol (HTTPS).

A peer-reviewed collection job can be created by manager 110 with platform 130 by manager 110 sending one or more (e.g., HTTP/S) network messages to invoke the API of platform 130 where the one or more network messages contain one or more data objects in a data serialization format defining the collection job for the platform 130 to create. No particular data serialization format is required. For example, the data serialization format can be Custom Markup Language (CML), CrowdFlower Markup Language (CML), eXtensible Markup Language (XML), JavaScript Object Notation (JSON), or the like. The data object can contain relevant information for use by platform 130 in creating the peer-reviewed collection job such as, for example, the source information item.

Before describing peer-reviewed collection jobs in greater detail below, source information items will first be described.

### Source Information Item

A source information item can be any item of information of which a natural language expression for use as a training example is desired. The type of the source information item can vary depending on the type of natural language processing task for which training data is being generated. No particular type of natural language processing tasks is required by the present invention.

For example, for a natural language processing task involving NER for natural language queries, a source information item can include information about an actual keyword search query submitted to a search engine for which a natural language expression of the actual keyword search query is desired. The actual keyword search query, and associated metadata, submitted to the search engine can be stored in query logs, for example.

A keyword search query submitted to the search engine can include one or more user entered keywords and/or one or more user entered keyphrases. In addition, the keyword search query can be associated with one or more user selected filters. Each user selected filter can be one filter among a set of pre-defined filters in a particular category of filters. For example, an online professional network might provide a “Industry” category of filters and a “Network” category of filters. The Industry category of filters might allow a searching user to limit his or her search to a particular selected industry such as, for example, “Information Technology,” among other possible selections available for the Industry filter. The Network category of filters might allow the searching user to limit his or her search to: (a) first degree connections, (b) first- and second-degree connections, or (c) first, second- and third-degree connections in the professional network, among other possible selections available for the Network filter. For example, a keyword search query submitted to the search engine might include the keyword “VP” with the “Information Technology” Industry filter and the “First Degree” Network filter. In this example, some possible natural language expressions of this keyword search query include, for example:
“Find VP in the IT industry from my professional network”
“Seek entry of IT industry in my professional network”
“Who do I know in information technology with the title of VP?”
“VP of IT in my network”

With regard to the above example, the online service can use the techniques disclosed herein to generate training data for training a NER system to recognize entities in natural language queries submitted by users of the online service. The techniques disclosed herein allow the online service to automatically generate the training data based on existing query logs containing actual keyword search queries previously submitted by users of the online service and logged. Ultimately, the trained NER system could be used to process natural language queries submitted by users of the online service. Thus, with the techniques disclosed herein, the online service can leverage its existing query log data to automatically generate training data for training a natural language query processor to process natural language queries.

As another example, for a natural language processing task involving natural language translation, a source information item can include a natural language expression in a source spoken language (e.g., English) for which a natural language expression in a target spoken language (e.g., Chinese) is desired. In this case, with the techniques disclosed herein, the online service can generate training data for training a natural language machine translator for translating existing text in a source spoken language to a target spoke language. The existing text might be, for example, English language comments, posts, tweets, or the like submitted by users of the online service that the online service wishes to translate to Chinese in order to present to Chinese language users of the online service.

While the online service can use the techniques disclosed herein to generate machine learning training data for a natural language processing task, the techniques can also be used by the online service to simply to generate natural language expressions such as, for example, for an image captioning task. For example, collection jobs can present digital images to crowd users in collection pool 150 and ask those crowd users to provide natural language expressions of what is depicted in the images (e.g., “a woman walking a dog on a beach”). The corresponding judging jobs can then be executed prompting crowd users in judging pool 160 to judge whether the natural language image captions provided by crowd users in collection pool 150 are well-formed (e.g., accurate). Online service can then use the well-formed image captions to build or maintain a text-annotated image database.

The above examples are just some examples of possible uses of the disclosed techniques and the present invention is not limited to any particular use of the disclosed techniques.

Regardless of whether set of source information items 112 includes actual keyword queries, digital images, or texts in a source spoken language, manager 110 can submit set of source information items 112 to platform 130 as peer-reviewed collection jobs. The purpose of having manager 110 create peer-reviewed collection jobs with platform 130 can be to generate set of training examples 114 based on set of source information items 112.

### Peer-Reviewed Collection Job

Turning now to peer-reviewed collection jobs, a peer-reviewed collection job created by manager 110 with platform 130 is executed by platform 130 and prompts crowd users in collection pool 150 at the crowd users' devices 152 with collection prompts 154. Different crowd users in collection pool 150 can be presented with different collection prompts. For example, crowd user Abe may be presented with a collection prompt for one source information item and crowd user Betty may be presented with a different collection prompt for a different source information item. The same crowd user in collection pool 150 may be presented with multiple different collection prompts. For example, crowd user Chris may be presented with a different collection prompt for each of multiple different source information items.

Collection pool 150 includes crowd users of platform 130 that are presented with collection prompts 154. To generate a diversity of responses for the same source information item, manager 110 can create multiple peer-reviewed collection jobs with platform 130 for the same source information item. For example, manager 110 might create multiple peer-reviewed collection jobs with platform 130 for the same actual keyword query so that different crowd users in collection pool 150 generate multiple candidate text expressions for the actual keyword query for subsequent judging by crowd users in judging pool 160. While manager 110 can create multiple peer-reviewed collection jobs for the same source information item, it is also possible for manager 110 to create just a single peer-reviewed collection job for a given source information item.

### Collection Prompt

A collection prompt of a peer-reviewed collection job can be for a respective source information item. When presented at a crowd user's device of a crowd user in collection pool 150, the collection prompt can present the source information item of the peer-reviewed collection job and a prompt for the crowd user to enter a natural language expression that describes, characterizes, or reformulates the presented source information item in natural language. In this way, a natural language expression of the source information item is solicited from the crowd user in collection pool 150.

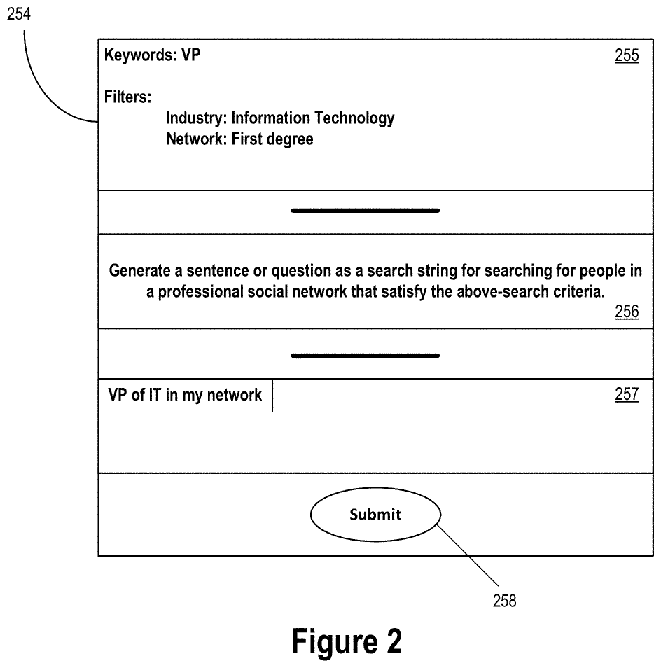

For example, FIG. 2 is a wire-frame depiction of example collection prompt 254. Collection prompt 254 can be presented in a computer graphical user interface at a crowd user's device of a crowd user in collection pool 150. The computer graphical user interface can be a web page of a web browser application running at user devices 152, a graphical user interface of a mobile application for using platform 130 from mobile ones of user devices 152, a communications application or other suitable computer graphical user interface capable of presenting collection prompt 254.

Collection prompt 254 includes source information item 255, collection task prompt 256, text expression entry area 257, and submit button 258. In this example, collection prompt 254 prompts 256 a crowd user in collection pool 150 viewing collection prompt at his or her user device to generate a sentence or question as a search string for searching for people in a professional social network that satisfy the search criteria of source information item 255. In this example, source information item 255 is an actual keyword query with keywords and filters harvested from query logs. In this example, the crowd user has formulated the actual keyword query as the text expression “VP of IT in my network” as entered with user input into text entry area 257. The crowd user may enter the text expression into text entry area 257 using any suitable computer user input mechanism (e.g., cursor point device (e.g., a mouse), physical keyword, soft keyboard, speech-to-text, etc.). Once the text expression is entered into text entry area 257, the crowd user can send/submit the input text expression to platform 130 by selecting submit button 258 with appropriate user input.

The crowd user may receive a payment from platform 130 for submitting a text expression to platform 130 that is prompted for by a collection prompt. For example, the payment can be a monetary payment, a crypto-currency payment, or other type of payment or reward for completing the collection task.

It should be noted that a crowd user may choose different text expressions to enter into a text area (e.g., 257) of a collection prompt (e.g., 254). For example, the crowd user might choose one of the following text expressions into input into text area 257 of collection prompt 254, some of which may be more useful than others for machine learning training purposes:
1. “Find VP in the IT industry from my LinkedIn network.”
2. “Seek entry of IT industry in my network”
3. “Who do I know in information technology field with title of VP?”
4. “keyword: VP and Industry: Information technology and Network: first degree”
5. “VP IT first degree”
6. “jfdialgr794##*?”

A text expression provided by a crowd user via a collection prompt may not be a well-formed natural language expression for the machine learning training task at hand. In the example in the preceding paragraph, text expressions 4, 5, and 6 are not sufficiently well-formed natural language expressions. Text expressions 4 and 5 include the search keywords and filters of the keyword search query 255 but not in a sentence or question form. Text expression 6 does not include the search keywords or filters at all.

### Auto-Routing Mechanism

To ensure that a text expression received from a crowd user via a collection prompt is a well-formed natural language expression, platform 130 can include auto-routing mechanism 132. By creating a peer-reviewed crowdsource job with platform 130, as opposed to creating merely a “plain-vanilla” crowdsource job with platform 130, manager 110 can invoke auto-routing mechanism 132 of platform 130 for the peer-reviewed crowdsource job. Auto-routing mechanism 132 can be configured to automatically create one or more judging jobs upon receipt by platform 130 of a text expression from a crowd user via a collection prompt of a peer-reviewed collection job.

When creating the peer-reviewed collection job, manager 110 can indicate that the auto-routing mechanism 132 should be invoked for the peer-reviewed collection job. This indication can be made in a variety of different ways and the present invention is not limited to any particular way. In general, however, the indication can be made to the API of platform 130 for creating collection jobs. In particular, API of platform 130 may offer the ability to manager 110 to create plain-vanilla collection jobs and peer-reviewed collection jobs.

Creation of plain-vanilla collections jobs with platform 130 do not cause platform 130 to invoke auto-routing mechanism 132 for the plain-vanilla collection jobs. For example, manager 110 can invoke the API of platform 130 to create a plain-vanilla collection job that simply solicits input from a crowd user in collection pool 150 but that does not invoke auto-routing mechanism 132 to create one or more judging jobs.

On the other hand, creation of peer-reviewed collection jobs with platform 130 causes platform 130 to invoke auto-routing mechanism 132 for the peer-reviewed collection jobs. For example, manager 110 can invoke the API of platform 130 to create a peer-reviewed collection job that solicits a natural language expression of a structured information item presented in a collection prompt (e.g., 254) from a crowd user in collection pool 150. Upon the crowd user submitting a text expression via the collection prompt (e.g., 254) of the peer-reviewed collection job and platform 130 receiving the submitted text expression, platform 130 can invoke auto-routing mechanism 132 to automatically create one or more judging jobs for judging the text expression submitted by the crowd user.

When invoking the API of platform 130 to create a collection job, manager 110 can indicate whether a plain-vanilla collection job should be created by platform 130 or whether a peer-reviewed collection job should be created by platform 130. Such indication may be made in the one or more data objects that are sent in the one or more network messages that invoke the API of platform 130 for creating the collection job.

For example, the one or more data objects may include a flag, an attribute, a property, or the like that indicates whether the collection job to be created by platform 130 should be created as a plain-vanilla collection job or as a peer-reviewed collection job. For example, the one or more data objects may contain an attribute-value pair in a human and machine-readable format that indicates the type of collection job for platform 130 to create. For example, a “<cml:route> element of a CML data object can have an attribute-value pair such as, for example, <cml:route peer-review=true . . . > to indicate that a peer-reviewed collection job should be created by platform 130. The absence of the peer-review attribute-value pair, or a value of “false,” for the pair can be specified to indicate that a plain-vanilla collection job, or other type of collection job, should instead be created by platform 130.

### Judging Quorum

When platform 130 completes execution of a peer-reviewed collection job by receiving a text expression from a crowd user in collection pool 150 via the collection prompt of the peer-reviewed collection job, auto-routing mechanism 132 can automatically create a corresponding quorum of multiple judging jobs. Each judging job in the quorum can be for judging the text expression received for the completed peer-reviewed collection job. A reason for creating a quorum of multiple judging jobs can be for platform 130 to collect multiple judgments of the text expression from multiple crowd users in judging pool 160. The text expression can be considered a well-formed natural language expression only if a threshold number of judgments of the quorum indicate that the text expression is a well-formed natural language expression. The threshold number can be a majority of judgements (i.e., at least one-half), a super-majority of judgments (e.g., more than one one-half such as at least two-thirds), or all judgments (i.e., unanimous).

In some instances, there are two quorums: a creation quorum and a judging quorum. The creation quorum is a predetermined number of judging jobs that are created by platform 130 for a peer-reviewed collection job. For example, the predetermined number of judging jobs might be between two and seven or more. The judging quorum is the minimum number of judgments that must be received by platform 130 in order to make a final determination of whether the text expression is a well-formed natural language expression. For example, the judging quorum might be at least two judgments. In this case where a creation quorum and a judging quorum, the text expression being judged by the creation quorum can be considered a well-formed natural language expression only if at least a judging quorum number of judgments of the creation quorum indicate that the text expression is a well-formed natural language expression.

### Judging Prompt

A judging prompt of a judging job can be for a corresponding peer-reviewed collection job. When presented at a crowd user's device of a crowd user in judging pool 160, the judging prompt can present the text expression received by platform 130 for the corresponding peer-reviewed collection job (and optionally present the source information item for the corresponding peer-reviewed collection job). The judging prompt can also present a prompt for the crowd user in the judging pool 160 to confirm that the text expression is a well-formed natural language expression. In this way, a judgment of the text expression received from a crowd user in collection pool 150 is solicited from a crowd user in judging pool 160.

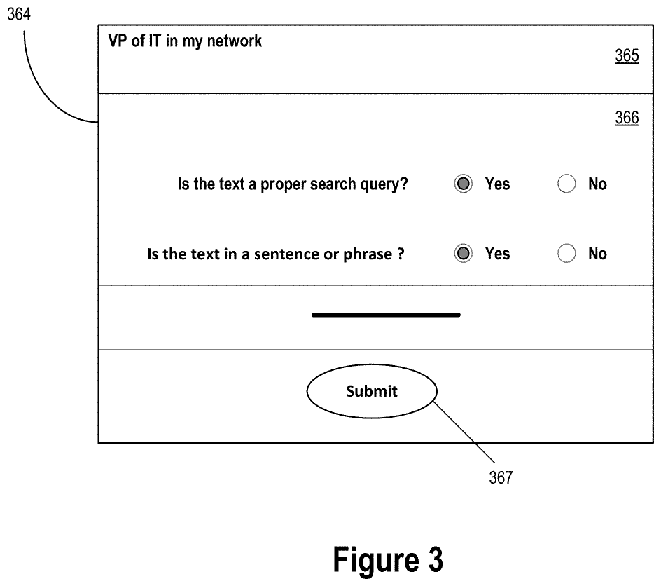

What is considered to be a well-formed natural language expression can vary depending on the intended use of the text expression being judged. For example, if the intended use of the text expression being judged is as a training example for training a NER system for natural language search query processing, then the text expression should be representative of a natural language search query. For example, FIG. 3 is a wire-frame depiction of example judging prompt 364 for judging a text expression received via collection prompt 254 of FIG. 2. Judging prompt 364 can be presented in a computer graphical user interface at a crowd user's device of a crowd user in judging pool 160. The computer graphical user interface can be a web page of a web browser application running at user devices 162, a graphical user interface of a mobile application for using platform 130 from mobile ones of user devices 162, a communications application or other suitable computer graphical user interface capable of presenting judging prompt 364.

Judging prompt 364 includes candidate text expression 365, limited answer questions 366, and submit button 367. In this example, collection prompt 364 prompts a crowd user in collection pool 160 viewing judging prompt 364 at his or her user device to select answers to limited answer questions 336 about candidate text expression 365. In this example, candidate text expression is “VP of IT in my network” and limited answer questions 366 ask: (a) whether candidate text expression 365 is a proper search query, and (b) whether candidate text expression 365 is a sentence of phrase. In this example, the crowd user has selected the “Yes” answer to both limited answer questions 366. The crowd user can then select the submit button 367 to send the selected answers to platform 130.

Limited answer questions are directed questions for which only a predefined set of possible answers are provided in the judging prompt. For example, limited answer questions 366 allow the crowd user to select only “Yes” or No” for each of questions. A limited answer question can have more than two (binary) possible answers. For example, a limited answer question can have a plurality of more than two possible answers that are selectable by the crowd user in the judging prompt such as, for example, via a drop-down select box or other suitable graphical user interface controls for selecting one answer from among the plurality of more than two possible answers. By limiting the possible answers, the judging task is made more easier for the crowd user and the selected answers more readily interpretable by a consumer of the selected answers (e.g., the online service), as opposed to if judgements were solicited from the crowd users in free-text form.

There can as few as one limited answer question presented in a judging prompt and more than two limited answer questions presented in a judging prompt depending on the requirements of the particular implementation at hand. For example, a limited answer question can simply ask whether the candidate text expression is a well-formed natural language expression. Alternatively, a series of specific limited answer questions can be presented in the judging prompt.

The answers selected by the crowd user to the limited answer questions presented in the judging prompt can be used to determine whether the candidate text expression presented in the judging prompt is a well-formed natural language expression (e.g., suitable for use as a training example). For example, it can be required that the crowd user select “Yes” to both of limited answer questions 366 in order for candidate text expression 365 to be considered a well-formed natural language expression. However, there is no requirement that the crowd user judging a candidate text expression presented in a judging prompt answer all of the presented limited answer questions in a particular way in order for the candidate text expression to be considered a well-formed natural language expression. The answers that are required in order for the candidate text expression to be considered a well-formed natural language expression may vary according to the requirements of the particular implementation at hand. For example, some limited answer questions can be optional for the crowd user to answer. Answers the optional questions can be used to determine a confidence score reflecting a confidence that the candidate text expression is a well-formed candidate text expression. As another example, some limited answer questions may be presented only if the crowd user answers other limited answer questions in a certain way such that a follow-up or continuing question is needed.

### Low Pay, High Bonus

A crowd user may receive a payment or reward based on submitting a text expression to platform 130 via a collection prompt of a peer-reviewed collection job. For example, a crowd user may receive a monetary payment after submitting text expressions for a predetermined number (e.g., a page) of peer-reviewed collection jobs. The predetermined number can be selected by the creator of the peer-reviewed collection job (e.g., an online service). For example, the predetermined number can be preconfigured with platform 130 by an online service.

For reasons previously explained, the text expression submitted by a crowd user via a collection prompt of a peer-reviewed collection job can be unsuitable for use as a training example in a machine learning training task. To encourage crowd users in collection pool 150 to submit high-quality text expressions (e.g., a text expression useful for a given machine learning training task), crowd users in collection pool 150 may receive a bonus payment or reward based on submitting text expressions that are judged to be well-formed natural language expressions by quorums of crowd users in judging pool 160. For example, a crowd user may receive a bonus monetary payment after submitting text expressions for a predetermined number (e.g., a page) of peer-reviewed collection jobs that are considered to be well-formed natural language expressions according to judgements by quorums of crowd users in judging pool 160. The bonus payment for submitting a page of text expressions judged to be well-formed natural language expressions by quorums of crowd users in judging pool 160 can be higher than the payment received merely by submitting the page of text expressions to platform 130. In this way, the crowd users in collection pool 150 are incentivized to submit high-quality text expressions.

For example, the bonus payment may be five times higher than the initial payment.

### Tagging Job

When platform 130 completes execution of a peer-reviewed collection job by receiving a text expression from a crowd user in collection pool 150 via the collection prompt of the peer-reviewed collection job, auto-routing mechanism 132 can also automatically create a corresponding quorum of multiple tagging jobs in addition to creating a quorum of multiple judging jobs corresponding to the completed peer-reviewed collection job. The number of tagging jobs in the corresponding quorum of tagging jobs can be equal to the number of judging jobs in the corresponding quorum of judging jobs. However, more or fewer tagging jobs can be created than the number of judging jobs that are created.

A purpose of a tagging job can be to solicit a crowd user in tagging pool 160 to tag entities in a text expression with one tag of a predefined set of tags. The tags included in the set of predefined set of tags may vary from training task to training task according to the requirements of the particular implementation at hand and no particular predefined set of tags is required. The tags may be used to trained a NER system or a POS tagger, for example.

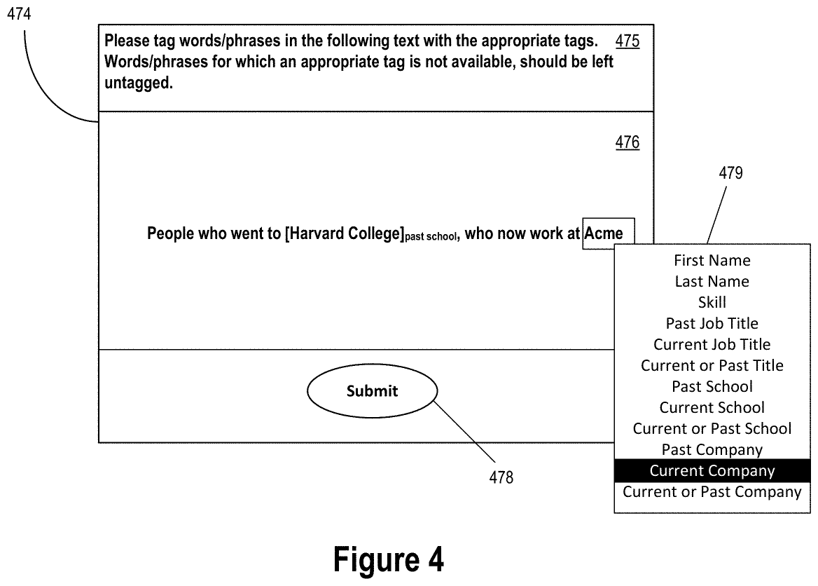

For example, FIG. 4 is a wire-frame depiction of example tagging prompt 474 of a tagging job. Tagging prompt 474 includes instructions 475 for a crowd user in tagging pool 160, text expression and tagging area 476, and submit button 478. The text expression can be one that is received by platform 130 by executing a collection job.

Tagging prompt 474 can be presented after platform 130 has executed a corresponding judging job. For example, a crowd user in judging pool 150 may be presented with a judging prompt of the judging job that asks whether text expression 476 is a well-formed natural language text expression. Upon answering “Yes”, the crowd user may then be presented with tagging prompt 474 of the tagging job. In this case, the same crowd user is in both judging pool 150 for the judging job and tagging pool 160 for the tagging job. Had the crowd user answered “No” to the judging prompt, then in that case the crowd user may not be presented with tagging prompt 474 because it may not be possible to usefully tag a text expression that is not well-formed.

While a same crowd user can complete a judging job and a tagging job for the same text expression, it is also possible for different crowd users to complete the jobs. For example, one crowd user in judging pool 150 can complete a judging job and another different crowd user in tagging pool 160 can complete the corresponding tagging job assuming the crowd user in judging pool 150 judged the text expression to well-formed.

Interfacing with tagging prompt 474, a crowd user can select keywords and keyphrases of well-formed natural language text expression 476 to tag. Upon the selection, a drop-down selection list or pop-up dialog is presented to allow the crowd user to select a particular tag for the selected keyword or keyphrase. In this example, the keyphrase “Harvard College” has already been tagged with the tag “past school.” The crowd user has selected the keyword “Acme” and selection list 479 is presented for the crowd user to assign one of the predefined set of tags to the keyword. For example, the crowd user might select the tag “current company” as the tag for the selected keyword “Acme”. Once the crowd user is finished assigning tags to keywords and keyphrases in the text expression 476, the crowd user can submit the tagged text expression to platform 130 by selecting submit button 478 with appropriate user input.

Like with a judging job, a quorum of completed tagging jobs where the crowd users tagged a keyword or a keyphrase all with the same particular tag may be required in order for the keyword or keyphrase to considered to have that tag. For example, the keyword “Acme” in text expression 476 may be considered to have the tag “current company” only if at least a majority, super majority, or all crowd users of a creation quorum of crowd users tag and submit the keyword “Acme” with the tag “current company” using their respective tagging prompts.

### Example Process

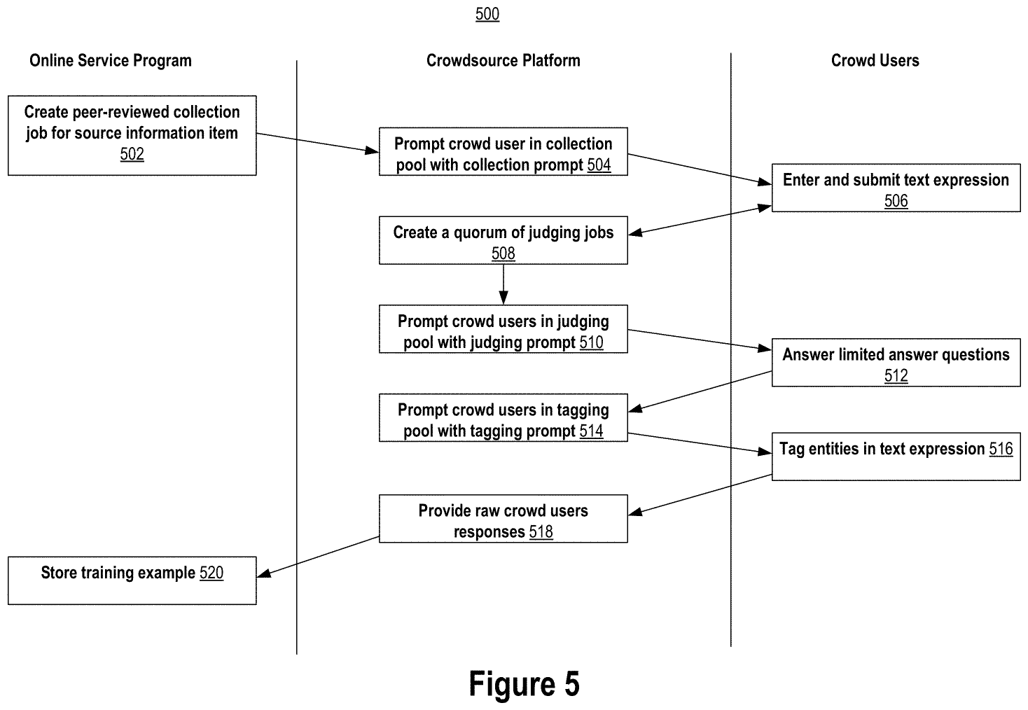

FIG. 5 is a flow diagram of example process 500 for generating machine learning training data for a natural language processing task. Process 500 may be performed at least once for each source information item in a set of source information items that serve as the basis for generating the training data. In particular, process 500 may be performed for a given source information item to automatically (from the perspective of the online service) generate a high-quality, peer-reviewed training example for inclusion in a set of training examples for a machine learning training task. Process 500 may be performed more than once for the same source information item to generate multiple training examples for the source information item.

At operation 502, an online service computer program invokes the API of the crowdsource platform to create a peer-reviewed collection job for a target source information item.

At operation 504, the crowdsource platform prompts a crowd user in the collection pool with a collection prompt for the peer-reviewed collection job. The collection job presents the target source information item and asks the crowd user to describe, characterize, or reformulate the target source information item as a natural language expression (e.g., as a sentence or phrase).

At operation 506, the crowd user enters and submits a candidate text expression via the collection prompt to the crowdsource platform.

At operation 508, the crowdsource platform receives the candidate text expression entered and submitted by the crowd user at operation 506 and subsequently creates a quorum of judging jobs for the candidate text expression.

At operation 510, the crowdsource platform prompts a quorum of crowd users in the judging pool with a judging prompt. The judging prompt asks each crowd user in the quorum one or more limited answer questions about the candidate text expression.

At operation 512, each crowd user in the quorum answers the one or more limited answer questions presented in the judging prompt.

At operation 514, answer(s) to the one or more limited answer questions presented in the judging prompt from one of the crowd users are received by the crowdsource platform. If the answer(s) received indicate that the candidate text expression is well-formed according to the crowd user, then that crowd user is prompted to tag the candidate text expression with a tagging prompt. If the answer(s) received indicate that the candidate text expression is not well-formed according to the crowd-user, then crowd user is not prompted with the tagging prompt. Operation 514 can be performed by crowdsource platform for each crowd user in the quorum that submits answer(s) to the one or more limited answer questions presented in the judging prompt.

At operation 516, crowd users in the quorum that provided answer(s) to the one or more limited answer questions presented in the judging prompt that indicate that the crowd users judged the candidate text expression as well-formed each respond to the tagging prompt by tagging entities in the candidate text expression with tags selected from a predefined set of tags.

At operation 518, the crowdsource platform receives a tagged/annotated candidate text expression from each of the crowd users that tagged the candidate text expression in operation 516. The raw answers from crowd users to the collection prompt, the judging prompt, and the tagging prompt are then provided to an online service program. The raw answers can be provided by crowdsource platform to the online service program in a variety of different formats and no particular format is required. For example, the raw answers could be provided in a comma separated value (CSV) format, an eXtensible Markup Language (XML), or other machine-readable data format.

At operation 520, an online service analyzes the raw answers to determine if a training example can be created for the target source information item. For example, the raw answers may be parsed. From the parsed raw answers, it can be determined if a quorum of crowd users judged the candidate text expression to be a well-formed natural language expression. If not, then no training example is generated from it. Otherwise, if a quorum of crowd users judged the candidate text expression to be a well-formed natural language expression, then it can be determined which keywords and keyphrases in the candidate text expression were tagged with the same tag by at least a quorum of crowd users. A training example can be generated based on the candidate text expression and the tags for the keywords and keyphrases that were tagged by at least a quorum of crowd users. For example, a NER system or a POS tagger can be trained to learn to predict the tags assigned by the crowd users to the keywords and keyphrases of the candidate text expression.

### Computing System Implementation

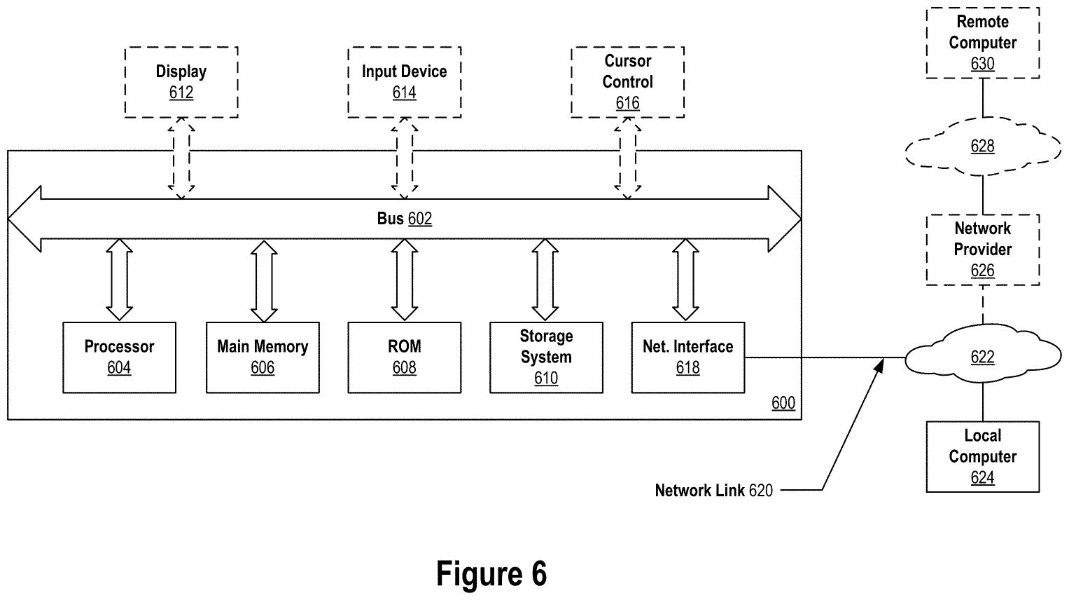

An implementation of the present invention may encompass performance of a method by a computing system having one or more processors and storage media. The one or more processors and the storage media may be provided by one or more computer systems. An example computer system is described below with respect to FIG. 6. The storage media of the computing system may store one or more computer programs. The one or more programs may include instructions capable of performing and configured to perform the method when executed by the one or more processors.

An implementation of the present invention may encompass one or more non-transitory computer-readable media. The one or more non-transitory computer-readable media may store the one or more computer programs that include the instructions which, when executed by one or more processors of a computing system, are capable of causing the computing system to perform the method.

An implementation of the present invention may encompass the computing system having the one or more processors and the storage media storing the one or more computer programs that include the instructions capable of performing and configured to perform the method when executed by the one or more processors.

An implementation of the present invention may encompass one or more virtual machines that operate on top of one or more computer systems and emulate virtual hardware. A virtual machine can be a Type-1 or Type-2 hypervisor, for example. Operating system virtualization using containers is also possible instead of, or in conjunction with, hardware virtualization using hypervisors.

For an implementation that encompasses multiple computer systems, the computer systems may be arranged in a distributed, parallel, clustered or other suitable multi-node computing configuration in which computer systems are continuously, periodically, or intermittently interconnected by one or more data communications networks (e.g., one or more internet protocol (IP) networks.) Further, it need not be the case that the set of computer systems that execute the instructions be the same set of computer systems that provide the storage media storing the one or more computer programs, and the sets may only partially overlap or may be mutually exclusive. For example, one set of computer systems may store the one or more computer programs from which another, different set of computer systems downloads the one or more computer programs and executes the instructions thereof.

FIG. 6 is a block diagram of example computer system 600 used in an implementation of the present invention. Computer system 600 includes bus 602 or other communication mechanism for communicating information, and one or more hardware processors coupled with bus 602 for processing information.

Hardware processor 604 may be, for example, a general-purpose microprocessor, a central processing unit (CPU) or a core thereof, a graphics processing unit (GPU), or a system on a chip (SoC).

Computer system 600 also includes a main memory 606, typically implemented by one or more volatile memory devices, coupled to bus 602 for storing information and instructions to be executed by processor 604. Main memory 606 also may be used for storing temporary variables or other intermediate information during execution of instructions by processor 604.

Computer system 600 may also include read-only memory (ROM) 608 or other static storage device coupled to bus 602 for storing static information and instructions for processor 604.

A storage system 610, typically implemented by one or more non-volatile memory devices, is provided and coupled to bus 602 for storing information and instructions.

Computer system 600 may be coupled via bus 602 to display 612, such as a liquid crystal display (LCD), a light emitting diode (LED) display, or a cathode ray tube (CRT), for displaying information to a computer user. Display 612 may be combined with a touch sensitive surface to form a touch screen display. The touch sensitive surface may be an input device for communicating information including direction information and command selections to processor 604 and for controlling cursor movement on display 612 via touch input directed to the touch sensitive surface such by tactile or haptic contact with the touch sensitive surface by a user's finger, fingers, or hand or by a hand-held stylus or pen. The touch sensitive surface may be implemented using a variety of different touch detection and location technologies including, for example, resistive, capacitive, surface acoustical wave (SAW) or infrared technology.

Input device 614, including alphanumeric and other keys, may be coupled to bus 602 for communicating information and command selections to processor 604.

Another type of user input device may be cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Instructions, when stored in non-transitory storage media accessible to processor 604, such as, for example, main memory 606 or storage system 610, render computer system 600 into a special-purpose machine that is customized to perform the operations specified in the instructions. Alternatively, customized hard-wired logic, one or more ASICs or FPGAs, firmware and/or hardware logic which in combination with the computer system causes or programs computer system 600 to be a special-purpose machine.

A computer-implemented process may be performed by computer system 600 in response to processor 604 executing one or more sequences of one or more instructions contained in main memory 606. Such instructions may be read into main memory 606 from another storage medium, such as storage system 610. Execution of the sequences of instructions contained in main memory 606 causes processor 604 to perform the process. Alternatively, hard-wired circuitry may be used in place of or in combination with software instructions to perform the process.

The term “storage media” as used herein refers to any non-transitory media that store data and/or instructions that cause a machine to operate in a specific fashion. Such storage media may comprise non-volatile media (e.g., storage system 610) and/or volatile media (e.g., main memory 606). Non-volatile media includes, for example, read-only memory (e.g., EEPROM), flash memory (e.g., solid-state drives), magnetic storage devices (e.g., hard disk drives), and optical discs (e.g., CD-ROM). Volatile media includes, for example, random-access memory devices, dynamic random-access memory devices (e.g., DRAM) and static random-access memory devices (e.g., SRAM).

Storage media is distinct from but may be used in conjunction with transmission media. Transmission media participates in transferring information between storage media. For example, transmission media includes coaxial cables, copper wire and fiber optics, including the circuitry that comprise bus 602. Transmission media can also take the form of acoustic or light waves, such as those generated during radio-wave and infra-red data communications.

Computer system 600 also includes a network interface 618 coupled to bus 602. Network interface 618 provides a two-way data communication coupling to a wired or wireless network link 620 that is connected to a local, cellular or mobile network 622. For example, communication interface 618 may be IEEE 602.3 wired “ethernet” card, an IEEE 602.11 wireless local area network (WLAN) card, an IEEE 602.15 wireless personal area network (e.g., Bluetooth) card or a cellular network (e.g., GSM, LTE, etc.) card to provide a data communication connection to a compatible wired or wireless network. In an implementation, communication interface 618 sends and receives electrical, electromagnetic or optical signals that carry digital data streams representing various types of information.

Network link 620 typically provides data communication through one or more networks to other data devices. For example, network link 620 may provide a connection through network 622 to local computer system 624 that is also connected to network 622 or to data communication equipment operated by a network access provider 626 such as, for example, an internet service provider or a cellular network provider. Network access provider 626 in turn provides data communication connectivity to another data communications network 628 (e.g., the internet). Networks 622 and 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the networks 622 and 628, network link 620 and communication interface 618. In the internet example, a remote computer system 630 might transmit a requested code for an application program through network 628, network 622 and communication interface 618. The received code may be executed by processor 604 as it is received, and/or stored in storage device 610, or other non-volatile storage for later execution.

### CONCLUSION

In the foregoing detailed description, the present invention has been described with reference to numerous specific details that may vary from implementation to implementation. The detailed description and the figures are, accordingly, to be regarded in an illustrative rather than a restrictive sense.

In the foregoing detailed description and in the appended claims, although the terms first, second, etc. are, in some instances, used herein to describe various elements, these elements should not be limited by these terms. These terms are only used to distinguish one element from another. For example, a first user interface could be termed a second user interface, and, similarly, a second user interface could be termed a first user interface, without departing from the scope of the various described implementations. The first user interface and the second user interface are both user interfaces, but they are not the same user interface.

As used in the foregoing detailed description and in the appended claims, the singular forms “a,” “an,” and “the” are intended to include the plural forms as well, unless the context clearly indicates otherwise. As used in the foregoing detailed description and in the appended claims, the term “and/or” refers to and encompasses any and all possible combinations of one or more of the associated listed items.

As used in the foregoing detailed description in the appended claims, the terms “based on,” “according to,” “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

For situations in which implementations discussed above collect information about users, the users may be provided with an opportunity to opt in or out of programs or features that may collect personal information. In addition, certain data may be anonymized in one or more ways before it is stored or used, so that personally identifiable information is removed. For example, a user's identity may be anonymized so that the personally identifiable information cannot be determined for or associated with the user, and so that user preferences or user interactions are generalized rather than associated with a particular user. For example, the user preferences or user interactions may be generalized based on user demographics.

1. A method performed by one or more processors, the method comprising:
creating a peer-reviewed collection job for a structured information item with a crowdsource platform, wherein the crowdsource platform executes using one or more computer systems;
receiving, from the crowdsource platform, a particular text expression of the structured information item and a confirmation that the particular text expression is well-formed; and
based on the receiving the particular text expression and the confirmation, including a training example, that is based on the particular text expression, in a training data set for training a machine learning model in a supervised learning manner for a natural language processing task.

2. The method of claim 1, wherein:
the peer-reviewed collection job, when executed by the crowdsource platform, causes a collection prompt to be presented at a crowd user device; and
the collection prompt, when presented at the crowd user device, presents the structured information item and prompts for user input of a text expression of the structured information item.

3. The method of claim 1, wherein:
the creating the peer-reviewed collection job causes the crowdsource platform to automatically create a judging job corresponding to the peer-reviewed collection job;
the judging job corresponding to the peer-reviewed collection job, when executed by the crowdsource platform, causes a judging prompt to be presented at a crowd user device; and
wherein the judging prompt, when presented at the crowd user device, presents the particular text expression and prompts for user input of a confirmation that the particular text expression is well-formed.

4. The method of claim 3, wherein:
the judging prompt, when presented at the crowd user device, prompts for user input to answer one or more limited answer questions;
the including the training example in the training data set is based on confirming that the particular text expression is well-formed;
the method further comprises receiving one or more user input answers to the one or more limited answer questions presented in the judging prompt; and
the confirming that the particular text expression is well-formed is based on the one or more user input answers received.

5. The method of claim 1, wherein:
the creating the peer-reviewed collection job causes the crowdsource platform to automatically create a tagging job corresponding to the peer-reviewed collection job;
the tagging job corresponding to the peer-reviewed collection job, when executed by the crowdsource platform, causes a tagging prompt to be presented at a crowd user device; and
wherein the tagging prompt, when presented at the crowd user device, presents the particular text expression and prompts for user input to assign a tag of a predefined set of tags to a keyword or keyphrase of the particular text expression.

6. The method of claim 1, further comprising:
creating a plurality of peer-reviewed collection jobs for a corresponding plurality of structured information items with the crowdsource platform; and
including the training example in the training data set before the crowdsource platform has executed all the plurality of peer-reviewed collection jobs.

7. The method of claim 1, further comprising:
training the machine learning model in the supervised learning manner for the natural language processing task based on the training example.

8. One or more non-transitory computer-readable media storing instructions capable, when executed by one or more processors, to perform:
creating a peer-reviewed collection job for a structured information item with a crowdsource platform; and
receiving, from the crowdsource platform, a particular text expression of the structured information item and a confirmation that the particular text expression is well-formed; and
based on the receiving the particular text expression and the confirmation, including a training example, that is based on the particular text expression, in a training data set for training a machine learning model in a supervised learning manner for a natural language processing task.

9. The one or more non-transitory computer-readable media of claim 8, wherein:
the peer-reviewed collection job, when executed by the crowdsource platform, causes a collection prompt to be presented at a crowd user device; and
the collection prompt, when presented at the crowd user device, presents the the structured information item and prompts for user input of a text expression of the structured information item.

10. The one or more non-transitory computer-readable media of claim 8, wherein:
the creating the peer-reviewed collection job causes the crowdsource platform to automatically create a judging job corresponding to the peer-reviewed collection job;
the judging job corresponding to the peer-reviewed collection job, when executed by the crowdsource platform, causes a judging prompt to be presented at a crowd user device; and
wherein the judging prompt, when presented at the crowd user device, presents the particular text expression and prompts for user input of a confirmation that the particular text expression is well-formed.

11. The one or more non-transitory computer-readable media of claim 8, wherein:
the judging prompt, when presented at the crowd user device, prompts for user input to answer one or more limited answer questions;
the including the training example in the training data set is based on confirming that the particular text expression is well-formed;
the instructions are capable, when executed by the one or more processors, to further perform receiving one or more user input answers to the one or more limited answer questions presented in the judging prompt; and
the confirming that the particular text expression is well-formed is based on the one or more user input answers received.

12. The one or more non-transitory computer-readable media of claim 8, wherein:
the creating the peer-reviewed collection job causes the crowdsource platform to automatically create a tagging job corresponding to the peer-reviewed collection job;
the tagging job corresponding to the peer-reviewed collection job, when executed by the crowdsource platform, causes a tagging prompt to be presented at a crowd user device; and
wherein the tagging prompt, when presented at the crowd user device, presents the particular text expression and prompts for user input to assign a tag of a predefined set of tags to a keyword or keyphrase of the particular text expression.

13. The one or more non-transitory computer-readable media of claim 8, wherein the instructions are capable, when executed by the one or more processors, to further perform:
creating a plurality of peer-reviewed collection jobs for a corresponding plurality of structured information items with the crowdsource platform; and
including the training example in the training data set before the crowdsource platform has executed all the plurality of peer-reviewed collection jobs.

14. The one or more non-transitory computer-readable media of claim 8, wherein the instructions are capable, when executed by the one or more processors, to further perform:
training the machine learning model in the supervised learning manner for the natural language processing task based on the training example.

15. A computing system comprising:
one or more processors;
storage media;
instructions stored in the storage media and configured for execution by the one or more processors, the instructions capable, when executed by the one or more processors, to perform:
creating a peer-reviewed collection job for a structured information item with a crowdsource platform; and
receiving, from the crowdsource platform, a particular text expression of the structured information item and a confirmation that the particular text expression is well-formed; and
based on the receiving the particular text expression and the confirmation, including a training example, that is based on the particular text expression, in a training data set for training a machine learning model in a supervised learning manner for a natural language processing task.

16. The computer system of claim 15, wherein:
the peer-reviewed collection job, when executed by the crowdsource platform, causes a collection prompt to be presented at a crowd user device; and
the collection prompt, when presented at the crowd user device, presents the the structured information item and prompts for user input of a text expression of the structured information item.

17. The computer system of claim 15, wherein:
the creating the peer-reviewed collection job causes the crowdsource platform to automatically create a judging job corresponding to the peer-reviewed collection job;
the judging job corresponding to the peer-reviewed collection job, when executed by the crowdsource platform, causes a judging prompt to be presented at a crowd user device; and
wherein the judging prompt, when presented at the crowd user device, presents the particular text expression and prompts for user input of a confirmation that the particular text expression is well-formed.

18. The computer system of claim 17, wherein:
the judging prompt, when presented at the crowd user device, prompts for user input to answer one or more limited answer questions;
the including the training example in the training data set is based on confirming that the particular text expression is well-formed;
the instructions are capable, when executed by the one or more processors, to further perform receiving one or more user input answers to the one or more limited answer questions presented in the judging prompt; and
the confirming that the particular text expression is well-formed is based on the one or more user input answers received.

19. The computer system of claim 15, wherein:
the creating the peer-reviewed collection job causes the crowdsource platform to automatically create a tagging job corresponding to the peer-reviewed collection job;
the tagging job corresponding to the peer-reviewed collection job, when executed by the crowdsource platform, causes a tagging prompt to be presented at a crowd user device; and
wherein the tagging prompt, when presented at the crowd user device, presents the particular text expression and prompts for user input to assign a tag of a predefined set of tags to a keyword or keyphrase of the particular text expression.

20. The computer system of claim 15, wherein the instructions are capable, when executed by the one or more processors, to further perform:
creating a plurality of peer-reviewed collection jobs for a corresponding plurality of structured information items with the crowdsource platform; and
including the training example in the training data set before the crowdsource platform has executed all the plurality of peer-reviewed collection jobs.
